(19) United States
(12) Patent Application Publication
(10) Pub. No.: US 2009/0021060 A1
(43) Pub. Date: Jan. 22, 2009

(54) HEADREST STRUCTURE FOR VEHICLE

(75) Inventors: Takashi Ishijima, Hino-shi (JP); Hideaki Katoh, Hino-shi (JP); Takahide Kirihara, Hino-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: HINO MOTORS, LTD., Hino-shi (JP)

(21) Appl. No.: 12/169,976

(22) Filed: Jul. 9, 2008

(30) Foreign Application Priority Data
Jul. 18, 2007 (JP) 2007-186816

(51) Int. Cl. B60N 2/42

(52) U.S. Cl. 297/216.12

(57) ABSTRACT

Projections capable of crushing a rear windowpane upon crash of a vehicle are arranged on a back of a stay embedded in a pad of a headrest. Thus, when the headrest strongly hits the rear windowpane upon crash of the vehicle, the rear windowpane is crushed by the projections in the form of metal pieces on upper rear portions of vertical stay portions of the stay, so that great impact is prevented from being applied on a head of an occupant.

### BACKGROUND OF THE INVENTION

1. Field of the Invention

The present invention relates to a headrest structure for a vehicle.

2. Description of the Related Art

Some vehicle 1 such as a small truck or so-called pickup as shown in FIG. 1 generally has a rear windowpane 5 arranged as shown in FIG. 2 backwardly of a headrest 4 so as to provide a partition between vehicle inside and outside, the headrest 4 being mounted on an upper end of a seat back 3b of a seat 3 having a seat cushion 3a on which an occupant 2 is seated.

Upon crash of the vehicle 1, especially upon rear-end crash, the whole of a body 6 is moved forward and the seat cushion 3a and the rear windowpane 5 follow the movement whereas a head 2a of the occupant 2 tends to remain unmoved due to inertia. As a result, the headrest 4 in its forward movement is blocked by the head 2a of the occupant 2 and strongly hits the rear windowpane 5 so that great impact may be applied on the head 2a of the occupant 2.

In order to overcome this, conventionally mounted on a rear of the headrest 4 is a shock absorber 7 such as resilient material as shown in FIG. 3 so as to relieve the impact on the head 2a of the occupant 2 upon crash of the vehicle 1.

A conventional headrest structure for a vehicle has been disclosed, for example, in JP 11-208339A.

However, mere mounting of the shock absorber 7 on the rear of the headrest 4 as mentioned above is hardly sufficient for relief of the impact on the head 2a of the occupant 2 upon crash of the vehicle 1. There still remains room for improvement.

The invention was made in view of the above and has its object to provide a headrest structure for a vehicle which can efficiently relive impact on a head of an occupant upon crash of a vehicle and is of help to protection of the occupant.

### SUMMARY OF THE INVENTION

The invention is directed to a headrest structure for a vehicle having a rear windowpane arranged backwardly of a headrest so as to provide a partition between vehicle interior and exterior, said headrest being mounted on an upper end of a seat back of a seat on which an occupant is seated, comprising at least a projection on a rear of a stay for the headrest and capable of crushing said rear windowpane upon crash of the vehicle.

The projection may be a separate member attached to the stay.

The stay may comprise vertical stay portions spaced apart from each other laterally of the headrest and a horizontal stay portion interconnecting said vertical stay portions, the projection being integrally provided on an upper portion of each of the vertical stay portions.

Embodiment of the invention will be described in conjunction with the drawings.

### BRIEF DESCRIPTION OF THE DRAWINGS

FIG. 1 is a perspective view showing a vehicle such as small truck or so-called pickup;

FIG. 2 is a side elevation in section showing vehicle interior in FIG. 1;

FIG. 3 is a side view showing a conventional headrest;

FIG. 4 is a side view showing a first embodiment of the invention;

FIG. 5 is a plan view in section showing the first embodiment or a sectional view looking in the direction of arrows V in FIG. 4;

FIG. 6 is a perspective view showing a second embodiment of the invention;

FIG. 7 is a side view showing the second embodiment of the invention;

FIG. 8 is a plan view in section showing the second embodiment or a view looking in the direction of arrows VIII in FIG. 7;

FIG. 9 is a perspective view showing a modification of the projection in the second embodiment;

FIG. 10 is a plan view in section showing the modification of the projection in the second embodiment or a view looking in the direction of arrows X in FIG. 9;

FIG. 11 is a side view showing a third embodiment of the invention;

FIG. 12 is a plan view in section showing the third embodiment or a view looking in the direction of arrows XII in FIG. 11; and

FIG. 13 is a plan view in section showing a modification of the projection in the third embodiment.

### DESCRIPTION OF THE PREFERRED EMBODIMENTS

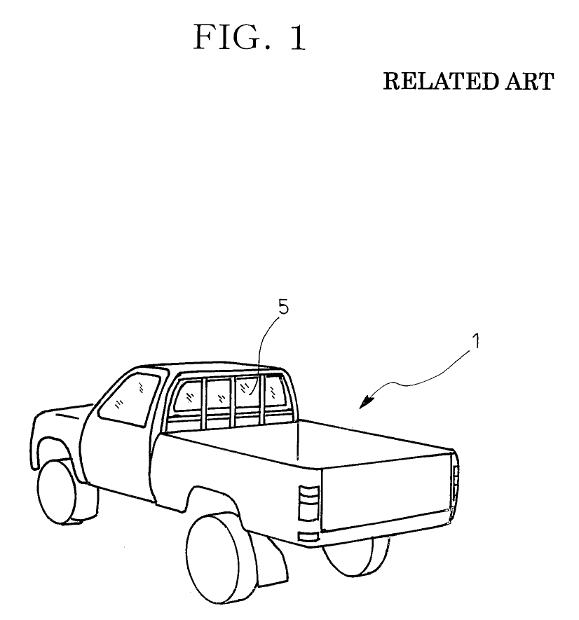

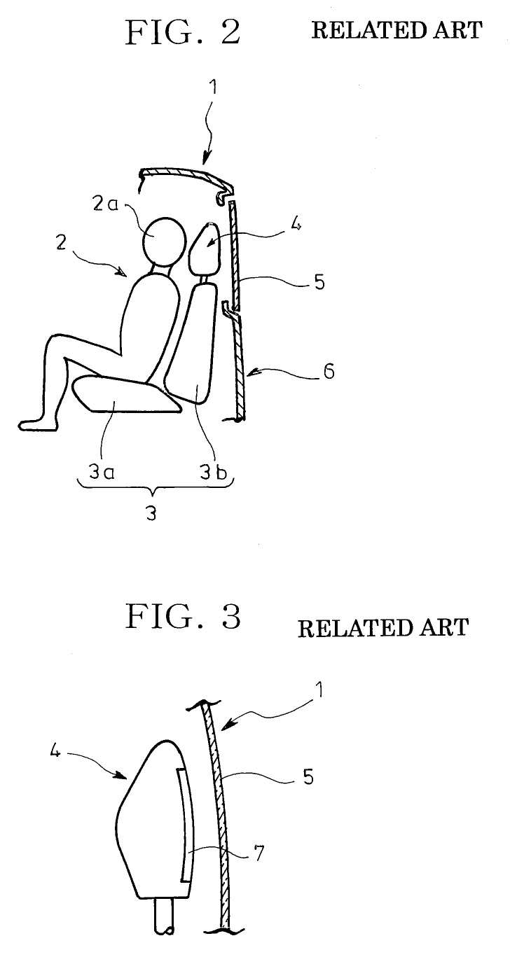

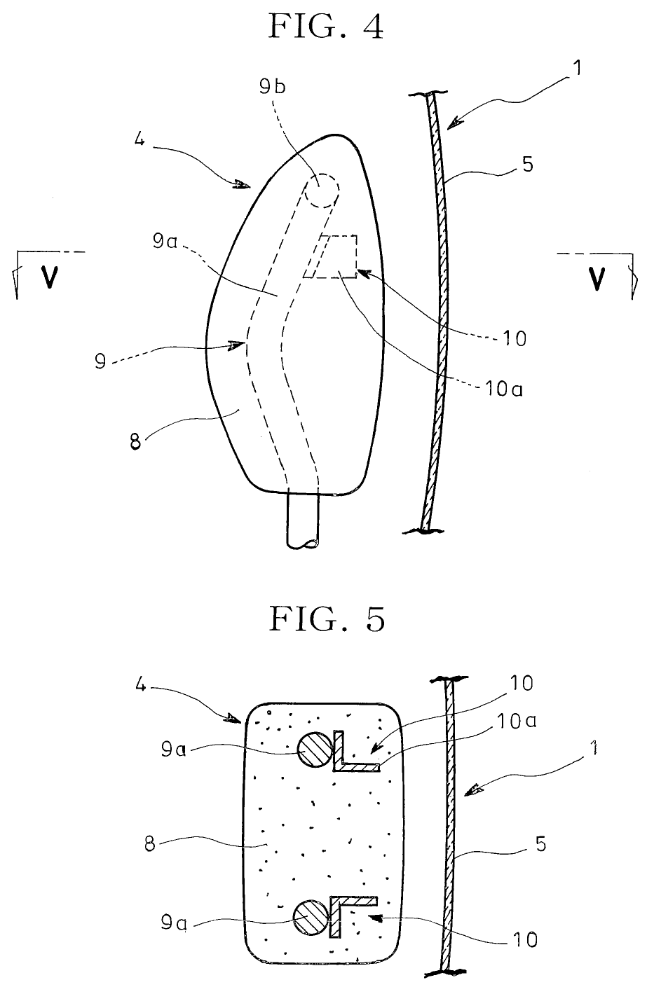

FIGS. 4 and 5 show a first embodiment of the invention in which parts similar to those in FIGS. 1-3 are represented by the same reference numerals, comprising projections 10 on a rear of a stay 9 embedded in a pad 8 of the headrest 4, the projections being capable of crushing the rear windowpane 5 upon crash of the vehicle 1.

In the first embodiment, the stay 9 comprises vertical stay portions 9a in the form of rods spaced apart from each other laterally of the headrest 4 and a horizontal stay portion 9b in the form of rod and interconnecting the vertical stay portions 9a. A curved metal piece 10a as a separate member is attached to an upper rear portion of each of the vertical stay portions 9a by for example welding, thereby providing the projection 10.

Next, a mode of operation of the first embodiment will be described.

When the headrest 4 strongly hits the rear windowpane 5 upon crash of the vehicle 1, the rear windowpane 5 is crushed by the projections 10 in the form of metal pieces 10a on the upper rear portions of the vertical stay portions 9a of the stay 9 of the headrest 4, so that great impact is prevented from being applied on the head 2a of the occupant 2.

A single metal piece 10a may be attached to lateral center of the horizontal stay portion 9b to provide the projection 10; this is advantageous from a viewpoint of reducing in number of parts in that the single metal piece 10a suffices. However, in view of various situations such as oblique rear-end crash, it is desirable that, as mentioned in the above, the projection 10 is provided on the upper rear portion of each of the vertical stay portions 9a.

Thus, the first embodiment can efficiently relieve the impact on the head 2a of the occupant 2 upon crash of the vehicle 1 and is of help for protection of the occupant 2.

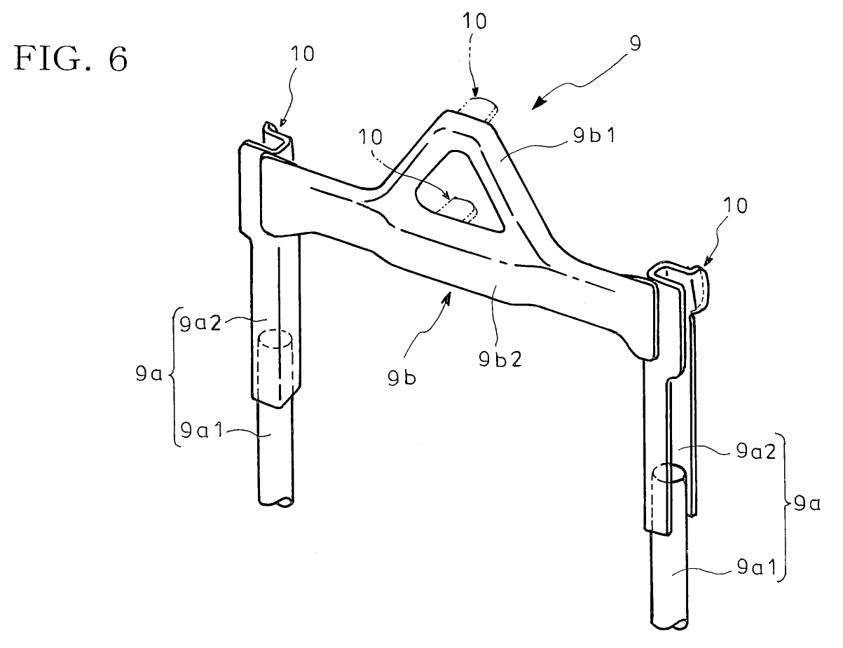

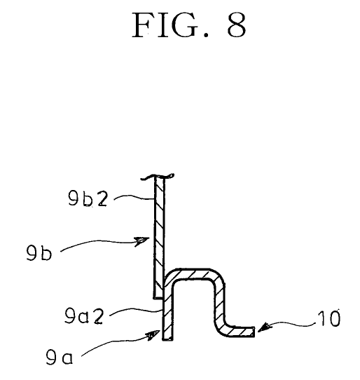

FIGS. 6-8 shows a second embodiment of the invention in which parts similar to those in FIGS. 4 and 5 are represented by the same reference numerals. Each of vertical stay portions 9a spaced apart from each other laterally of a headrest 4 comprises a cylindrical rod member 9a1 and a vertical frame member 9a2 with substantially U-shaped section attached to and extending upwardly from an upper portion of the rod member 9a1. A horizontal stay portion 9b interconnecting the vertical stay portions 9a comprises a horizontal frame member 9b2 laterally centrally formed with an upward triangular portion 9b1 by, for example, press working, the projection 10 being integrally formed on an upper portion of the vertical frame member 9a2 of each of the vertical stay portions 9a.

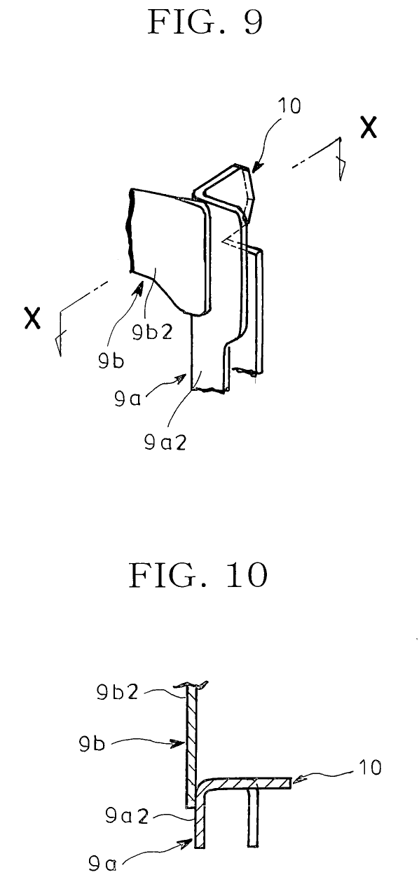

As shown in FIGS. 6-8, the projection 10 is formed by partly bending the vertical frame member 9a2. Alternatively, as shown in FIGS. 9 and 10, it may be formed by bending the vertical frame member 9a2 at a different position; alternatively, though not shown, the horizontal frame member 9b2 may be formed with cutouts at its opposite ends which are bent to provide the projections 10.

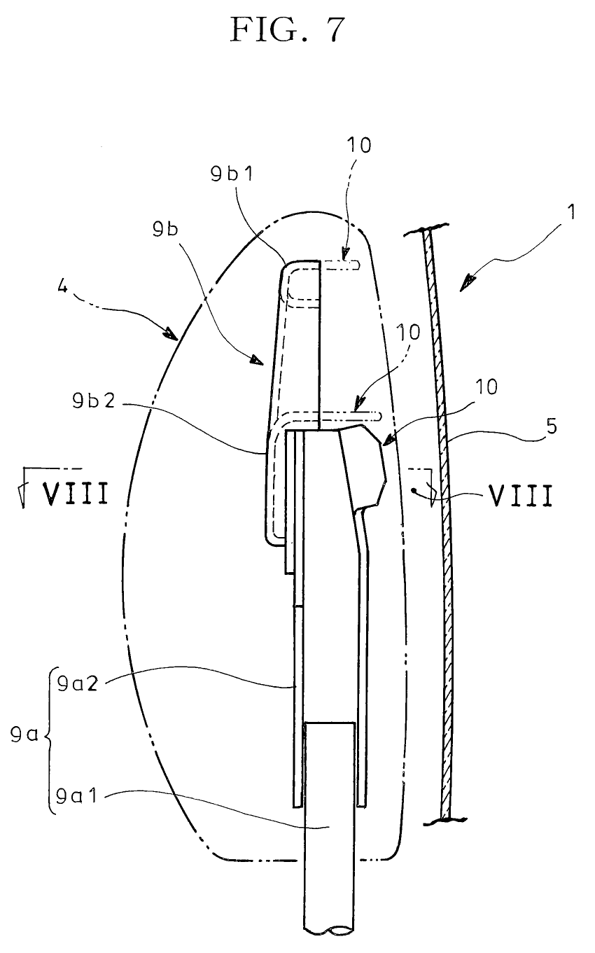

Alternatively, as shown in imaginary lines in FIGS. 6 and 7, the projection 10 may protrude from an upper or lower back of the upward portion 9b1 laterally centrally of the horizontal frame member 9b2.

In the second embodiment shown in FIGS. 6-8, when the headrest 4 strongly hits the rear windowpane 5 upon crash of the vehicle 1, the rear windowpane 5 is crushed by the projection 10 integrally formed on the upper rear portion of each of the vertical stay portions 9a of the stay 9 of the headrest 4, so that great impact is prevented from being applied on the head 2a of the occupant 2. Of course, it is also possible that upon crash of the vehicle 1 the rear windowpane 5 is crushed by the projection 10 protruding the upper or lower back of the upward portion 9b1 laterally centrally formed on the horizontal frame member 9b2 shown in imaginary lines in FIGS. 6 and 7 or by the projections 10 shown in FIGS. 9 and 10, so that great impact is prevented from being applied on the head 2a of the occupant 2.

Thus, just like the first embodiment shown in FIGS. 4 and 5, the second embodiment shown in FIGS. 6-8 and its modification shown in FIGS. 9 and 10 can effectively relieve the impact on the head 2a of the occupant 2 and are of help to protection of the occupant 2 upon crash of the vehicle 1.

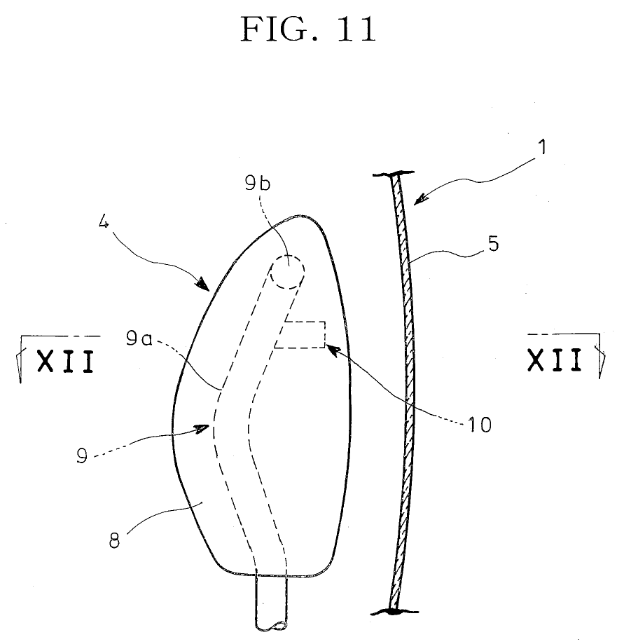

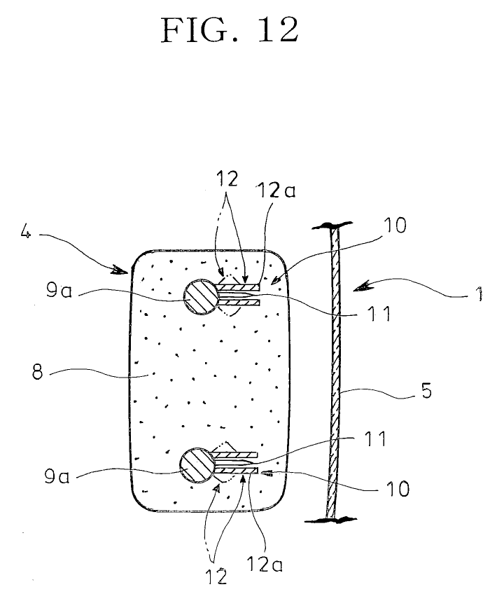

FIGS. 11 and 12 show a third embodiment of the invention in which parts similar to those in FIGS. 4 and 5 are represented by the same reference numerals, the fundamental structure being the same as that shown in FIGS. 4 and 5. This embodiment is characteristic in that, as shown in FIGS. 11 and 12, each of projections 10 comprises a pin 11 protruding from an upper back portion of each of vertical stay portions 9a of a stay 9 of a headrest 4 and usually covered with a covering member 12 which is resiliently deformed to reveal a tip of the pin 11 as shown in imaginary lines in FIG. 12 when the headrest 4 hits the rear windowpane 5 upon crash of the vehicle 1.

In this embodiment, the covering member 12 is in the form of a cylinder 12a made of resilient member such as rubber and has length usually slightly longer than the pin 11.

In the third embodiment shown in FIGS. 11 and 12, the pin 11 is usually covered with the covering member 12 in the form of cylinder 12a made of for example rubber, so that the occupant can touch a back of the headrest 4 with no acmesthesia and thus with no discomfort.

Meanwhile, when the headrest 4 strongly hits the rear windowpane 5 upon crash of the vehicle 1, the cylinder 12a as the covering member 12 of the projection 10 on the upper rear portion of the vertical stay portion 9a of the stay 9 of the headrest 4 is resiliently deformed as shown in imaginary lines in FIG. 12 to reveal the tip of the pin 11 which crushes the rear windowpane 5, so that great impact is prevented from being applied on the head 2a of occupant 2.

Thus, just like the first embodiment shown in FIGS. 4 and 5, the third embodiment shown in FIGS. 11 and 12 can efficiently relieve the impact on the head 2a of the occupant 2 upon crash of the vehicle 1 and is of help to the protection of the occupant 2, and further enables the occupant to usually touch the back of the headrest 4 with no acmesthesia and thus no discomfort.

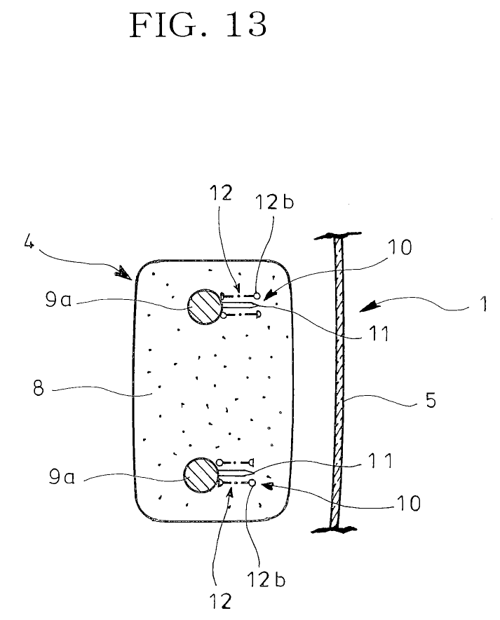

FIG. 13 shows a modification of the projection in the third embodiment of the invention in which parts similar to those in FIGS. 11 and 12 are represented by the same reference numerals, the fundamental structure being the same as that shown in FIGS. 11 and 12. This modification is characteristic in that, as shown in FIG. 13, each of projections 10 comprises a pin 11 protruding from an upper back portion of each of vertical stay portions 9a of a stay 9 of a headrest 4 and usually covered with a compression spring 12b as a covering member 12 which is compressed to reveal a tip of the pin 11 as shown in imaginary lines in FIG. 12 when the headrest 4 hits the rear windowpane 5 upon crash of the vehicle 1.

In the modification shown in FIG. 13, the pin 11 is usually covered with the compression spring 12b as the covering member 12, so that the occupant can touch the back of the headrest 4 with no acmesthesia and thus with no discomfort.

Meanwhile, when the headrest 4 strongly hits the rear windowpane 5 upon crash of the vehicle 1, the compression spring 12b as the covering member 12 of the projection 10 on the upper rear portion of the vertical stay portion 9a of the stay 9 of the headrest 4 is compressed to reveal the tip of the pin 11 which crushes the rear windowpane 5, so that great impact is prevented from being applied on the head 2a of the occupant 2.

Thus, just like the third embodiment shown in FIGS. 11 and 12, its modification shown in FIG. 13 can efficiently relieve the impact on the head 2a of the occupant 2 upon crash of the vehicle 1 and is of help to the protection of the occupant 2 and further enables the occupant to usually touch the back of the headrest 4 with no acmesthesia and thus no discomfort.

It is to be understood that a headrest structure for a vehicle according to the invention is not limited to the above embodiments and that various changes and modifications may be made without leaving from the scope of the invention.

What is claimed is:

1. A headrest structure for a vehicle having a rear windowpane arranged backwardly of a headrest so as to provide a partition between vehicle interior and exterior, said headrest being mounted on a upper end of a seat back of a seat on which an occupant is seated, comprising at least a projection on a back of a stay for the headrest and capable of crushing said rear windowpane upon crash of the vehicle.

2. A headrest structure for a vehicle as claimed in claim 1, wherein said projection is a separate member attached to said stay.

3. A headrest structure for a vehicle as claimed in claim 1, wherein said stay comprises vertical stay portions spaced apart from each other laterally of the headrest and a horizontal stay portion for interconnecting said vertical stay portions, said projection being integrally formed on an upper back portion of each of said vertical stay portions.
